(19) United States
(12) Patent Application Publication
(10) Pub. No.: US 2026/0327922 A1
(43) Pub. Date: Oct. 22, 2026

(54) WHEEL ASSEMBLY FOR PLATE COMPACTOR

(71) Applicant: MILWAUKEE ELECTRIC TOOL CORPORATION, Brookfield, WI (US)

(72) Inventors: Mason B. Lehman, South Whitley, IN (US); Erich G. Thuer, Menomonee Falls, WI (US)

(21) Appl. No.: 19/650,471

(22) Filed: Apr. 17, 2026

Related U.S. Application Data
(60) Provisional application No. 63/791,000, filed on Apr. 18, 2025.
(60) Provisional application No. 63/816,137, filed on Jun. 2, 2025.

(51) Int. Cl. E01C 19/40; B60B 37/00; E01C 19/48

(52) U.S. Cl. CPC E01C 19/402; B60B 37/00; E01C 19/4853

(57) ABSTRACT

A compactor includes a plate having a lower surface defining a plane, a frame coupled to the plate, a drive assembly including a motor and an exciter for receiving torque from the motor to vibrate the plate, and a wheel assembly pivotably coupled to the frame. The wheel assembly includes an axle, a plurality of wheels coupled to the axle, and a linkage assembly coupling the axle to the frame. The linkage assembly is configured to move the wheels between a deployed position, in which the wheels are tangent with the plane and rearward of the plate, and a stowed position, in which the wheels are positioned above the plate.

### CROSS REFERENCE TO RELATED APPLICATIONS

The present application claims priority to U.S. Provisional Patent Application No. 63/816,137, filed Jun. 2, 2025, and U.S. Provisional Patent Application No. 63/791,000, filed Apr. 18, 2025, the entire contents of both of which are incorporated herein by reference.

### FIELD OF THE DISCLOSURE

The present disclosure relates to plate compactors, and more specifically to a wheel assembly for transporting a plate compactor.

### BACKGROUND OF THE DISCLOSURE

Plate compactors include a plate that vibrates in order to compact soil or other loose material. However, plate compactors tend to be very heavy, which makes them not easily mobile. Therefore, many conventional plate compactors include systems for transporting plate compactors, such as removable carts, removable wheels, or transport rollers directly coupled to the plate compactor. A problem with existing transportation systems, however, is that existing transportation systems can interfere with the operation of the vibrating plate.

### SUMMARY OF THE DISCLOSURE

The present disclosure provides, in one aspect, a compactor including a plate having a lower surface defining a plane, a frame coupled to the plate, a drive assembly including a motor and an exciter for receiving torque from the motor to vibrate the plate, and a wheel assembly pivotably coupled to the frame. The wheel assembly includes an axle, a plurality of wheels coupled to the axle, and a linkage assembly coupling the axle to the frame. The linkage assembly is configured to move the wheels between a deployed position, in which the wheels are tangent with the plane and rearward of the plate, and a stowed position, in which the wheels are positioned above the plate.

The present disclosure provides, in another aspect, a compactor including a compactor including a plate having a lower surface defining a plane, a frame coupled to the plate, a drive assembly including a motor and an exciter for receiving torque from the motor to vibrate the plate, and a fluid distribution system selectively mountable to the frame. The fluid distribution system includes a tank defining an internal volume for storing a fluid, and a plurality of distribution tubes mounted to the tank and extending along a longitudinal axis that is parallel with the plane. The distribution tubes are fluidly coupled to the tank to receive and distribute the fluid. The fluid distribution system also includes a flow rate adjustment assembly for adjusting a fluid flow rate from the tank through the distribution tubes. The flow rate adjustment assembly has a shaft configured to rotate about a rotational axis, an adjustment knob coupled to the shaft, and a valve configured to selectively allow fluid into the distribution tubes in response to rotation of the shaft about the rotational axis.

The present disclosure provides, in another aspect, a compactor including a plate having a lower surface defining a plane, a frame coupled to the plate, a drive assembly configured to vibrate the plate, a protective pad removably mountable to the lower surface of the plate, and a fastening system configured to secure the protective pad to the plate. The fastening system includes a plurality of fasteners configured to engage corresponding apertures formed in the plate, and a plurality of tethers securing the respective fasteners to the plate or the protective pad such that the fasteners remain attached to the plate or the protective pad when the protective pad is removed from the plate.

Other features and aspects of the disclosure will become apparent by consideration of the following detailed description and accompanying drawings.

### BRIEF DESCRIPTION OF THE DRAWINGS

FIG. 1 is perspective view of a plate compactor according to an embodiment of the present disclosure.

FIG. 2 is an enlarged perspective view of the plate compactor of FIG. 1, illustrating a wheel assembly.

FIG. 3 is a rear view of the plate compactor and wheel assembly of FIG. 2.

FIG. 4 is perspective view of the wheel assembly for use with the plate compactor of FIG. 1.

FIG. 4A is a side, cross-sectional view of the wheel assembly of FIG. 4 taken along section line 4A-4A.

FIG. 5 is an enlarged perspective view of the plate compactor and wheel assembly of FIG. 2 with portions removed for clarity.

FIG. 6 is a side view of the plate compactor of FIG. 1 with the wheel assembly in a deployed position.

FIG. 7 is a side view of the plate compactor of FIG. 1 with the wheel assembly in a stowed position.

FIGS. 8A-8D illustrate a sequential movement of the wheel assembly from the deployed position of FIG. 6 to the stowed position of FIG. 7.

FIG. 9 is a perspective view of a baseplate of the plate compactor of FIG. 1 with an attached pad.

FIG. 10 is an enlarged perspective view of the baseplate of FIG. 9.

FIG. 11 is a side, cross-sectional view of the baseplate of FIG. 9 taken along section line 10-10.

FIG. 12 is a perspective view of a water distribution system for use with the plate compactor of FIG. 1.

FIG. 13 is a front view of the water distribution system of FIG. 12.

FIG. 14 is a side, perspective view of the water distribution system of FIG. 12 with portions made transparent for clarity.

FIG. 15 is a perspective view of a flow rate adjustment assembly of the water distribution system of FIG. 12.

FIG. 16 is a cross-sectional view of the flow rate adjustment assembly of FIG. 15 taken along section line 16-16.

FIG. 17 is a cross-sectional view of a water bar of the water distribution system of FIG. 12 taken along section line 17-17.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

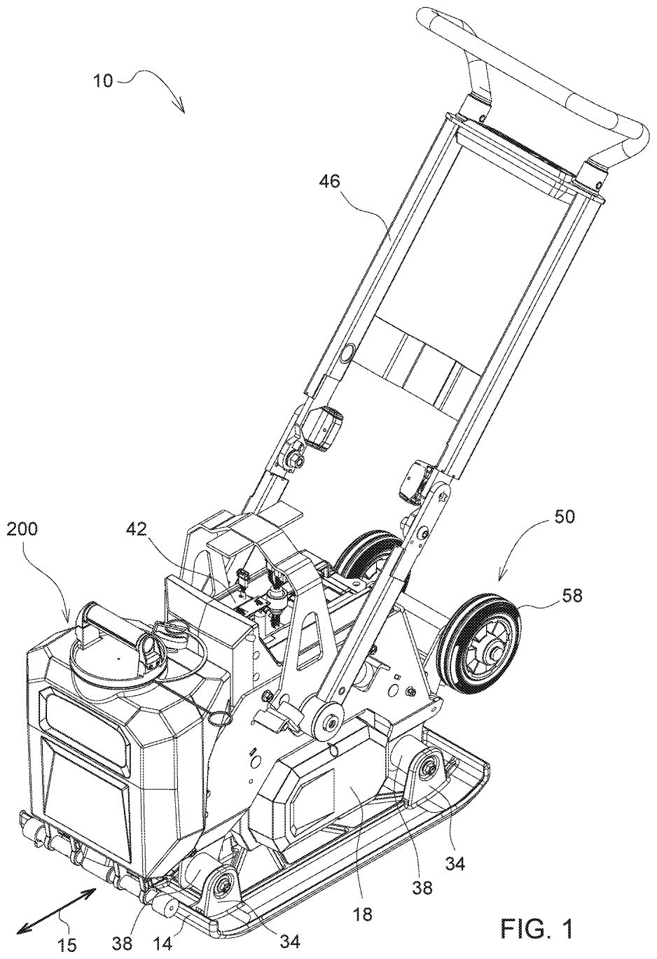

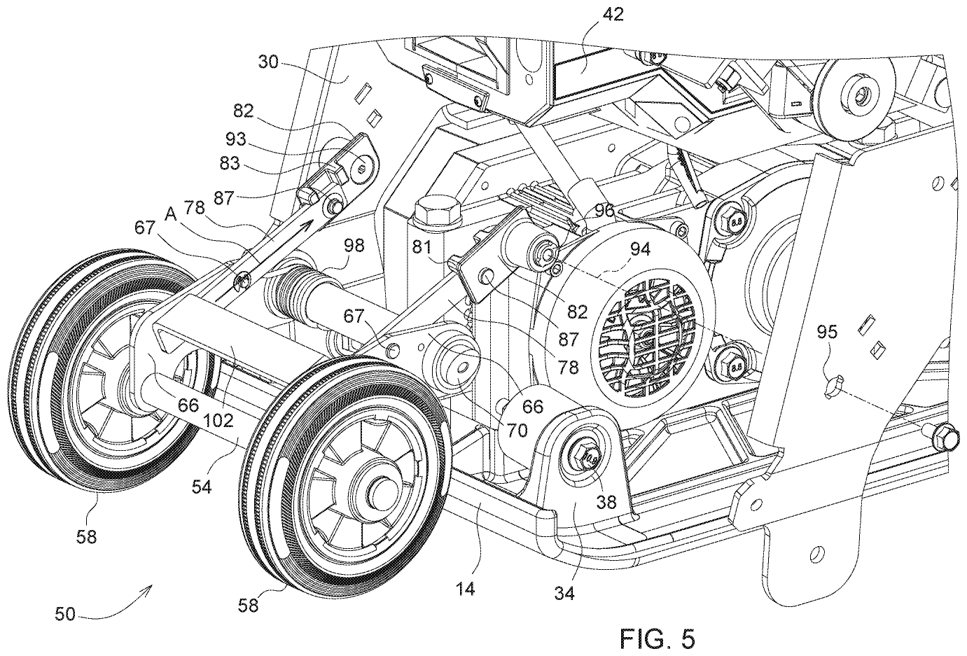

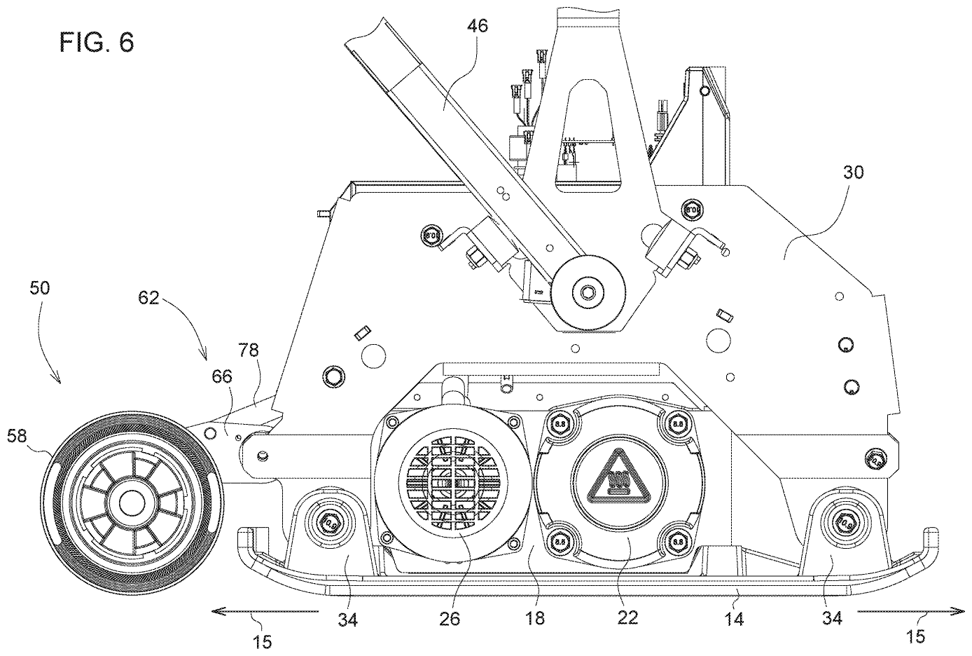

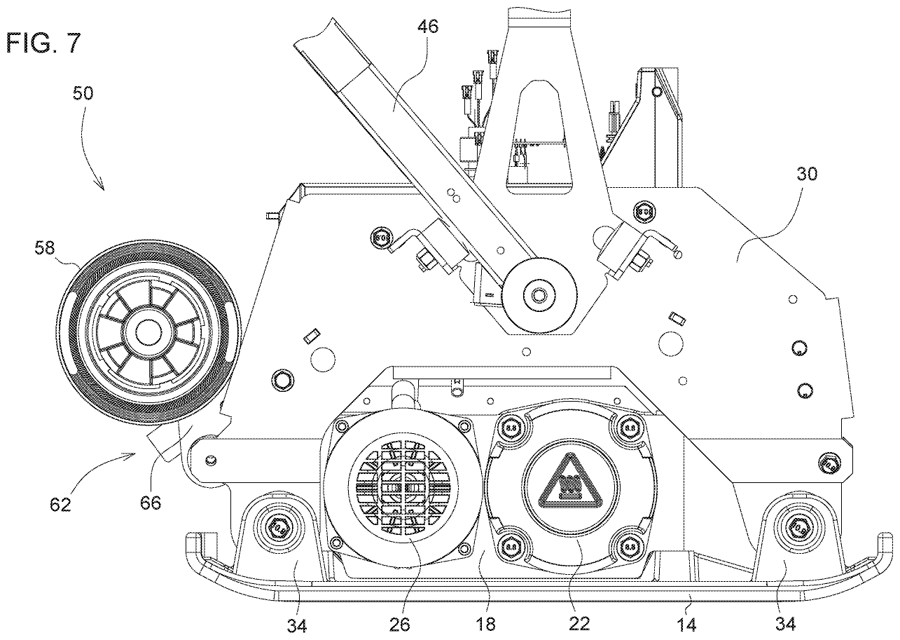

FIG. 1 illustrates a plate compactor 10 in accordance with an embodiment of the present disclosure. The plate compactor 10 includes a baseplate 14 defining a plane 15 along a bottom or lower surface of the baseplate 14 that contacts a support surface, and a drive housing 18 mounted to the baseplate 14 for housing an exciter assembly 22 (FIG. 5) and an electric motor 26 for providing torque to the exciter assembly 22 to vibrate the baseplate 14. The plate compactor 10 further includes a frame 30 coupled to the baseplate 14 via a plurality of attachment points 34. The frame 30 is vibrationally isolated from the baseplate 14 via a plurality of vibration dampers, such as springs or isolators 38, that are positioned between the frame 30 and each of the attachment points 34. A battery pack (not shown) is also mounted on the frame 30 within a battery receptacle 42 and configured to provide power to the electric motor 26. The plate compactor 10 further includes a handle 46 extending from the frame 30 to allow the compactor 10 to be maneuvered, and a wheel assembly 50 mounted to the frame 30 movable between a stowed position (FIGS. 1, 7) where the wheels 58 are located above the baseplate 14, and a deployed position (FIG. 6) where the wheels 58 are tangent with the plane 15 and located behind the baseplate 14.

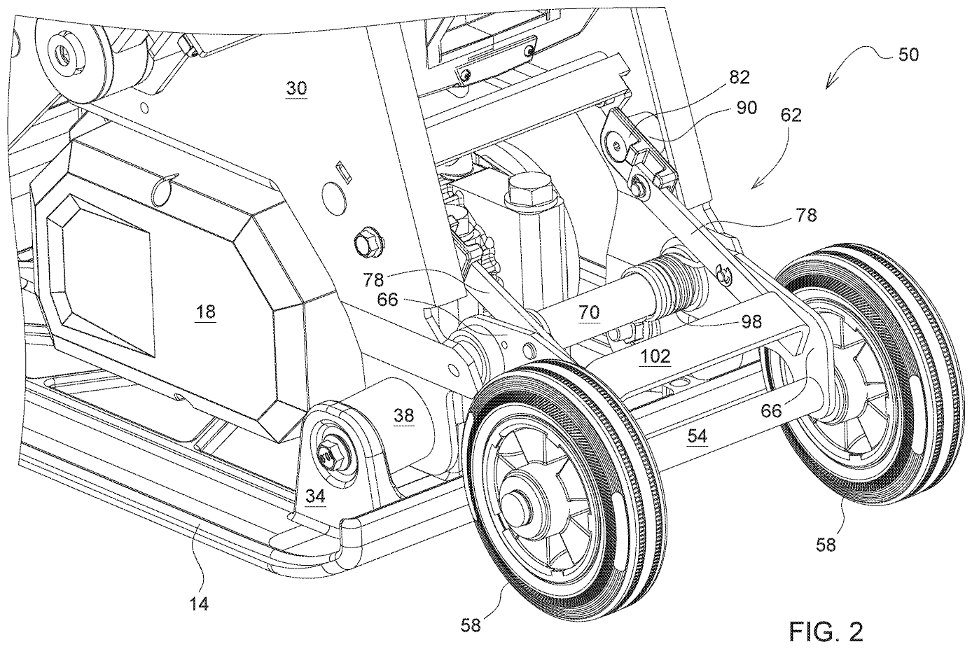

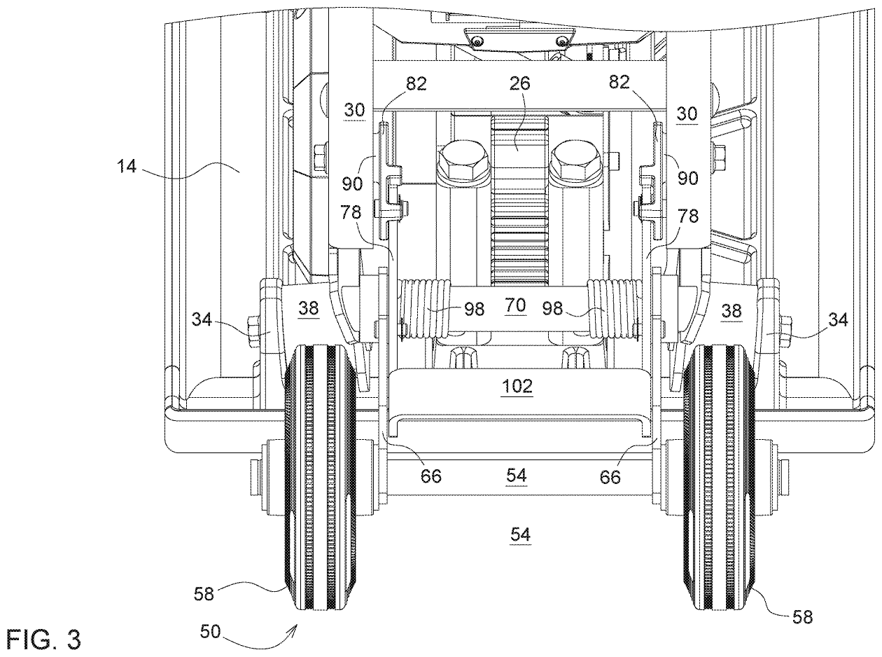

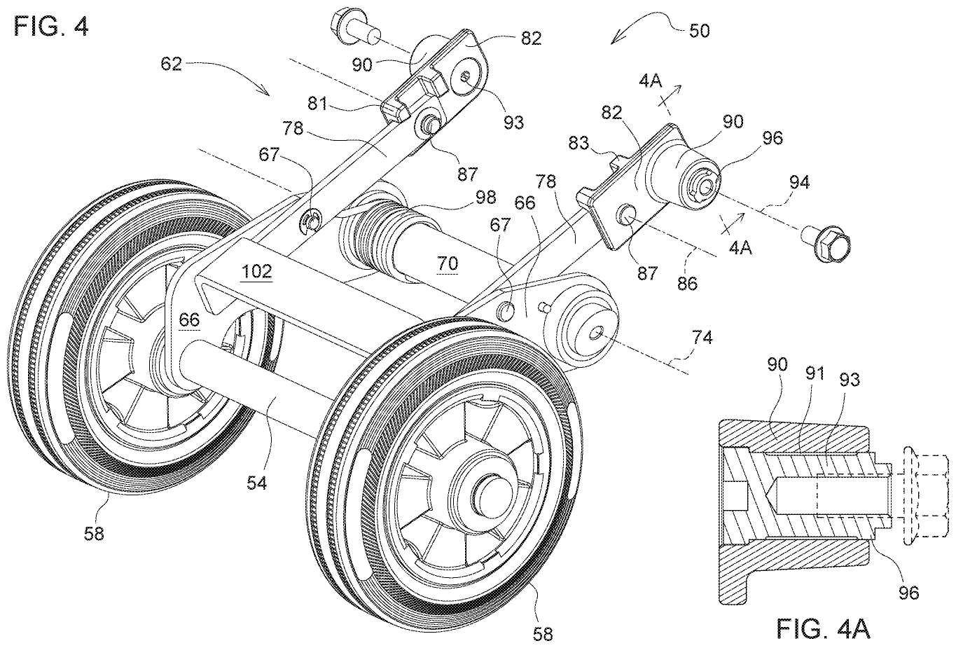

FIGS. 2-5 illustrate the wheel assembly 50, which is pivotably coupled to the frame 30. The wheel assembly 50 includes an axle 54 having wheels 58 coupled to either side of the axle 54, and a linkage assembly 62 disposed on either side of the axle 54 for coupling the axle 54 to the frame 30. The linkage assembly 62 is configured to move the wheel assembly 50 between the stowed position and the deployed position. In some embodiments, the linkage assembly 62 is a four-bar linkage. The linkage assembly 62 includes a driver link 66 having a first end fixedly coupled to the axle 54 and a second end pivotably coupled to a support rod 70 coupled to the frame 30. The support rod 70 extends along a driver axis 74 (FIG. 4) that is oriented parallel to the axle 54. The linkage assembly 62 further includes a connecting link 78 having a first end pivotably coupled to a middle section of the driver link 66 via a pivot joint 67 and a second end rotatably coupled to a driven link 82 via a pivot joint 87 about a rotational axis 86 parallel to the driver axis 74.

Each of the driven links 82 includes a first end rotatably coupled to the connecting link 78 via the pivot joint 87 and a second, or distal end pivotably coupled to an attachment sleeve 90 via a pivot joint 93 that is coupled to the frame 30. The attachment sleeve 90 includes a central bore 91 (FIG. 4A) in which the pivot joint 93 is rotatably received. When the pivot joint 93 is received in the central bore 91, a distal end 96 of the pivot joint 93 extends beyond the attachment sleeve 90. The remaining portion of the pivot joint 93 remains inside the central bore 91 and supports the weight of the attachment sleeve 90. The distal end 96 of each of the pivot joints 93 has a non-circular profile and is received within a corresponding shape hole 95 (FIG. 5) in the frame 30. In the illustrated embodiment, each of the pivot joints 93 and the hole 95 includes a “bowtie” cross-sectional shape. When the distal end 96 of the pivot joint 93 is inserted through the hole 95, the bowtie profiles prevent rotation of the pivot joint 93 relative to the frame 30, such that the pivot joints 93 rotatably support the respective attachment sleeves 90. The attachment sleeve 90 extends along a driven axis 94 (FIG. 4) that is oriented parallel to the rotational axis 86.

With continued reference to FIGS. 2-5, the compactor 10 also includes a plurality of torsion springs 98 fastened on either side of the support rod 70 that are configured to bias the wheel assembly 50 into the stowed position, and a step 102 formed on respective first ends of the connecting links 78 and extending therebetween.

With reference to FIG. 4, each of the pivot joints 67, 87, 93 that connect the links 66, 78, 82 of the linkage assembly 62 can be fasteners (e.g., bolts, screws etc.). Additionally, each of the driven links 82 include a first stop 81 and a second stop 83 that are each configured to selectively engage the second end of the connecting link 78 during movement between the stowed and deployed positions that is explained in greater detail below.

With reference to FIG. 5, the wheels 58 can be latched in the deployed position against the bias of the torsion springs 98 to lock the wheel assembly 50 in place during movement of the compactor 10. The wheel assembly 50 is maintained in the latched position by the first stop 81 on each of the connecting links 78 to keep a line of action A of the connecting links 78 extending through pivot joints 67, 87 below the pivot joint 93 and driven axis 94. When the step 102 is depressed, the driver link 66 is pivoted downward, which also pivots the connecting link 78 relative to the driven link 82, and tilts the line of action A above the pivot joint 93 and driven axis 94, thereby permitting the torsion springs 98 to unwind and bias the wheels 58 toward the stowed position.

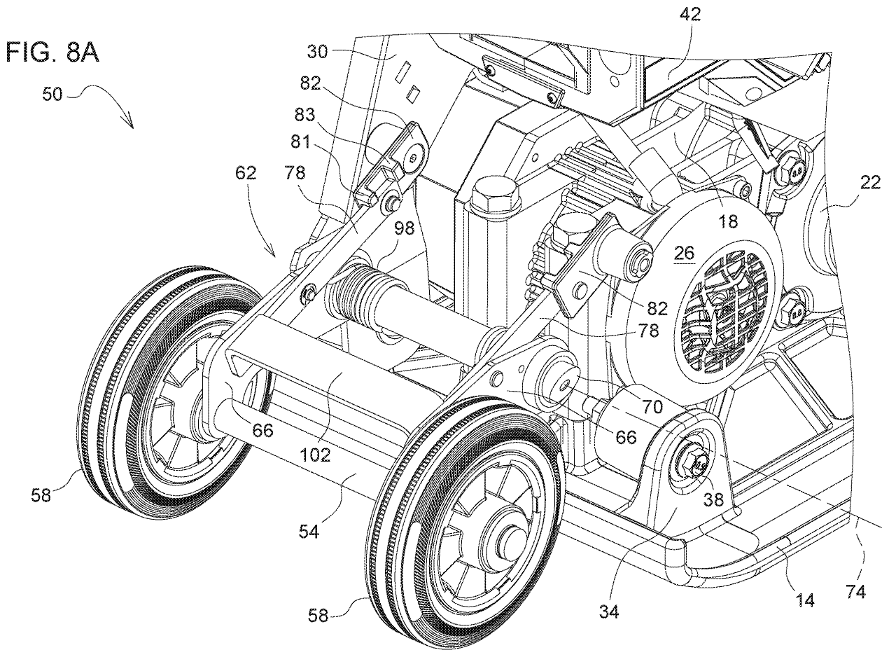

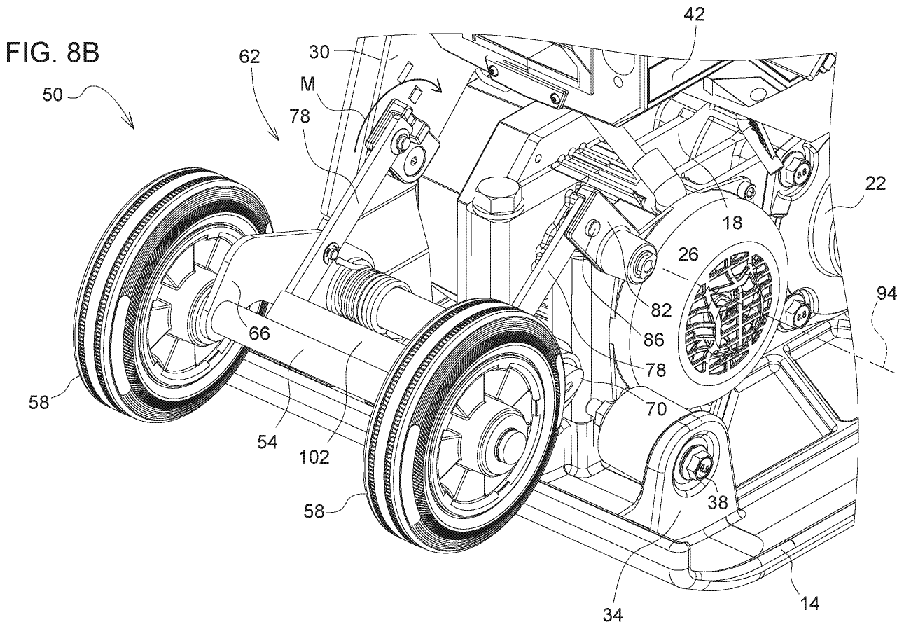

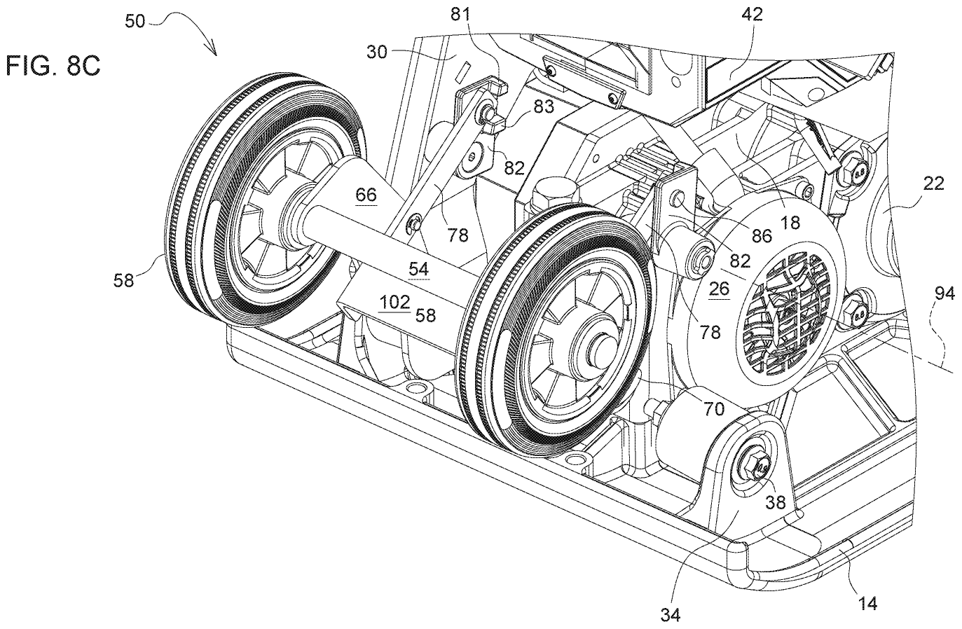

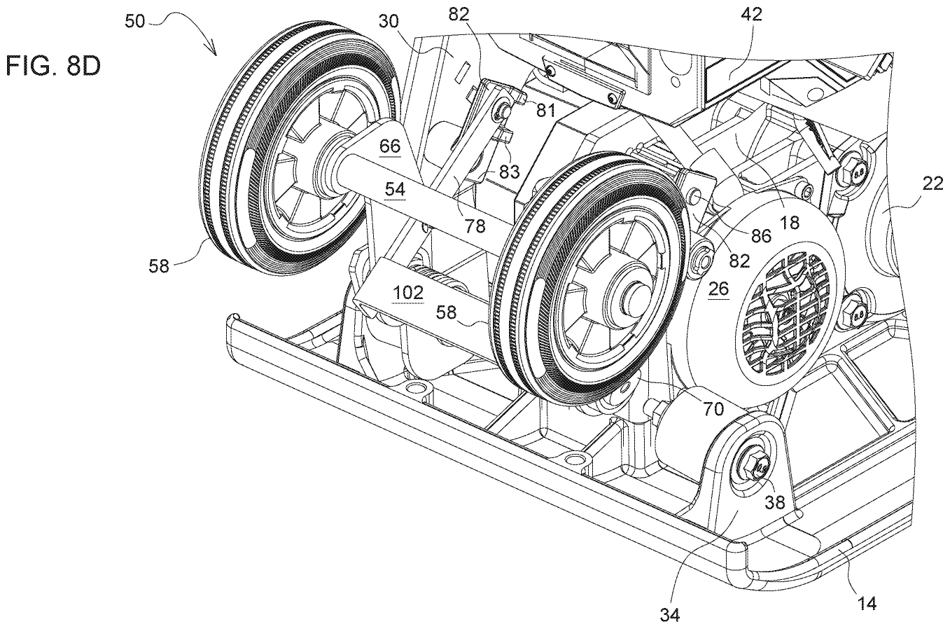

FIGS. 8A-8D illustrate the sequential movement of the wheels 58 of the wheel assembly 50 from the deployed position (FIG. 6) to the stowed position (FIG. 7). FIG. 8A illustrates the wheel assembly 50 in an initial deployed position. In the deployed position, the first stop 81 is in engagement with the second end of the connecting link 78 to prevent over rotation of the linkage assembly 62. To move the wheel assembly 50 to the stowed position, the step 102 is depressed (e.g., by the foot of a user) against the bias of the torsion springs 98. This movement unlatches the wheel assembly 50, thereby allowing the assembly 50 to move with the bias of the torsion springs 98. The biasing force from each of the torsion springs 98 causes each of the driver links 66 to pivot about the driver axis 74. This motion is transferred to the connecting links 78 via the pivot joint 67 and imparts a moment M (FIG. 8B) to the driven links 82 about the rotational axis 86. The moment M causes each of the driven links 82 to rotate about the rotational axis 86.

With reference to FIGS. 8B-8D, as the driven links 82 continue to rotate about the rotational axis 86 with the bias of the torsion springs 98, each of the driven links 82 travel over-center. That is, the rotational axis 86 of the driven links 82 translates across the driven axis 94 such that the respective second ends of each of the driven links 82 move from the left side (from the frame of reference of FIG. 8B) of the driven axis 94 to the right side of the driven axis 94 (FIG. 8C). Once the driven links 82 have completely traveled over-center (FIG. 8D), the wheel assembly 50 has pivoted into the stowed position and is prevented from further rotation by the connecting links 78 abutting the second stop 83 on the driven links 82. To maintain the wheel assembly 50 in the stowed position, the torsion springs 98 keep tension on the wheel assembly 50 until the wheel assembly 50 is moved toward the deployed position. To move the wheel assembly 50 into the deployed position, the axle 54 is depressed to pivot the driver link 66 downward against the bias of the torsion springs 98.

Utilizing the wheel assembly 50 allows for easier maneuverability compared to other conventional plate compactors. When the wheel assembly 50 is in the deployed position, the user simply needs to use the handlebars 46 to pivot the compactor 10 rearward toward the user onto the wheels 58 to maneuver the compactor 10 to the desired location. This is in contrast to other conventional compactors where the user needs to pivot the wheels below the baseplate in order to maneuver the compactor. However, in the illustrated embodiment, the wheel assembly 50 does not cross below, or intersect the plane 15 of the baseplate 14 when the wheel assembly 50 is moved to the deployed position. This is advantageous for the user when operating the compactor 10 because the wheel assembly 50 does not interfere with the vibration of the baseplate 14 during use.

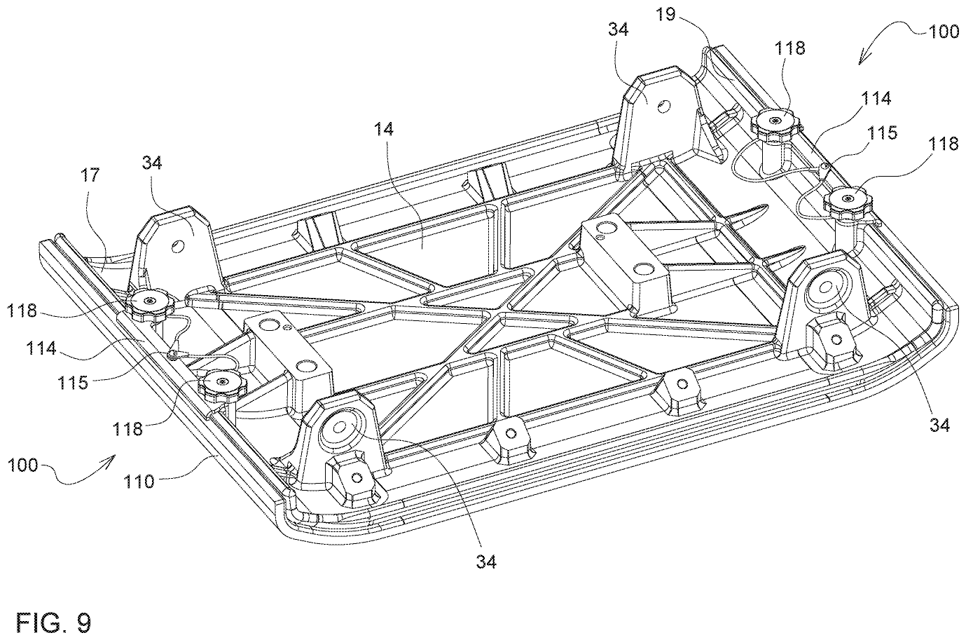

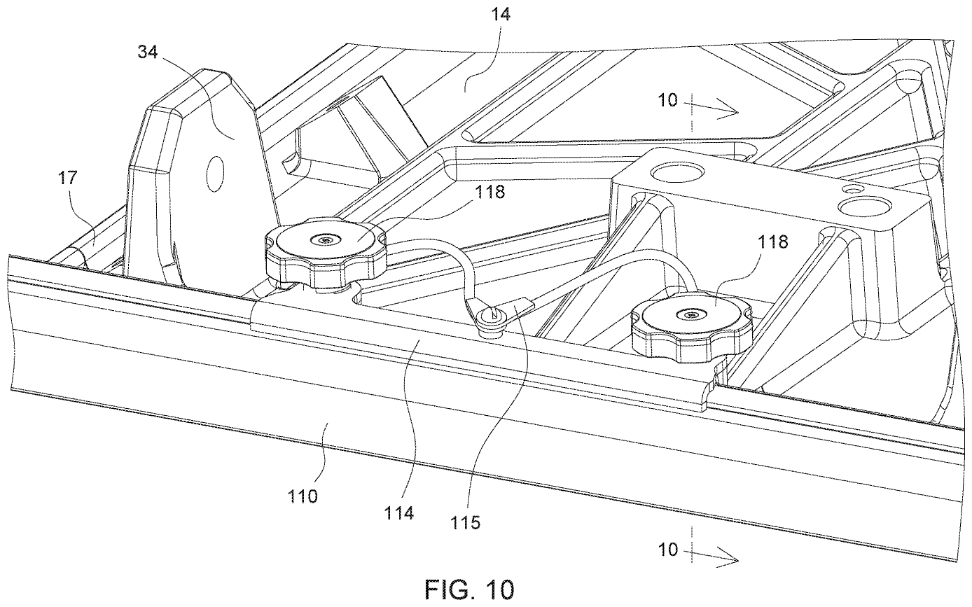

FIGS. 9-11 illustrate a protective pad 110 mountable to the bottom of the baseplate 14 to prevent marring on a decorative surface (e.g., brick pavers). In some embodiments, the pad 110 is comprised of a non-marring material, such as polyurethane or rubber. In other embodiments, the pad 110 is comprised of other non-marring materials known in the art. In the illustrated embodiment, each side of the pad 110 includes a metal bracket 114 integrally molded within the pad 110 for selectively mounting the pad 110 to the baseplate 14 via a fastening system 100 onboard the baseplate 14.

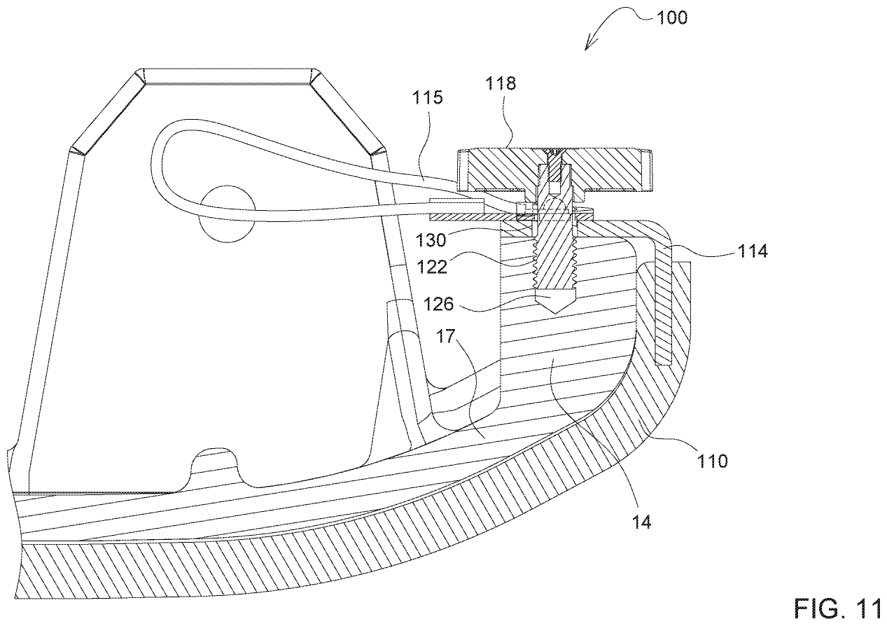

The fastening system 100 includes a plurality of fasteners 118 tethered to both a front side 17 and a rear side 19 of the baseplate 14. While the illustrated embodiment includes two fasteners 118 each located on the front and the rear sides 17, 19 of the baseplate 14, other embodiments may include more or fewer fasteners 118 that are located on different sides of the baseplate 14. Each of the fasteners 118 is a threaded fastener (e.g., a threaded knob) including external threads 122 (FIG. 11) configured to mate within internal threads of corresponding blind bores 126 located in the baseplate 14. In other embodiments, the fasteners 118 may be other types of fasteners, such as ¼ turn fasteners, or other known fasteners.

In the illustrated embodiment, each of the fasteners 118 is secured to the metal bracket 114 by a tether 115 so that the fasteners 118 do not get lost when the pad 110 is removed. In an alternative embodiment, the tether 115 is secured to a point directly on the baseplate 14. In yet other embodiments, the fasteners 118 may be attached to the baseplate 14 by other means.

To attach the pad 110 to the baseplate 14, the pad 110 is positioned beneath the bottom of the baseplate 14 and the blind bores 126 in the baseplate 14 are aligned with corresponding apertures 130 in the metal bracket 114. Next, each of the fasteners 118 is threaded into the respective blind bores 126 on the baseplate 14 to clamp the bracket 114 to the baseplate 14, thereby securing the pad 110 to the baseplate 14.

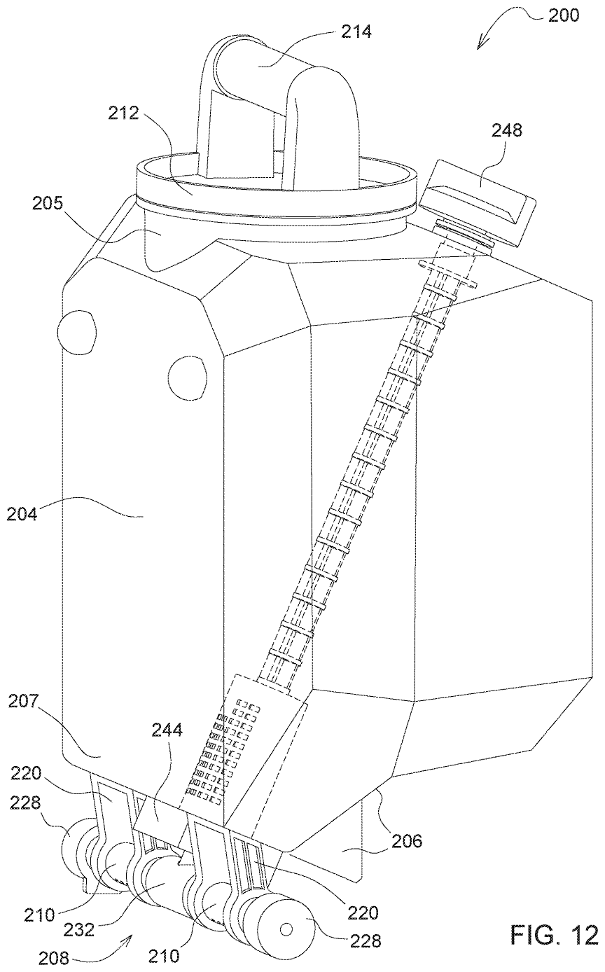

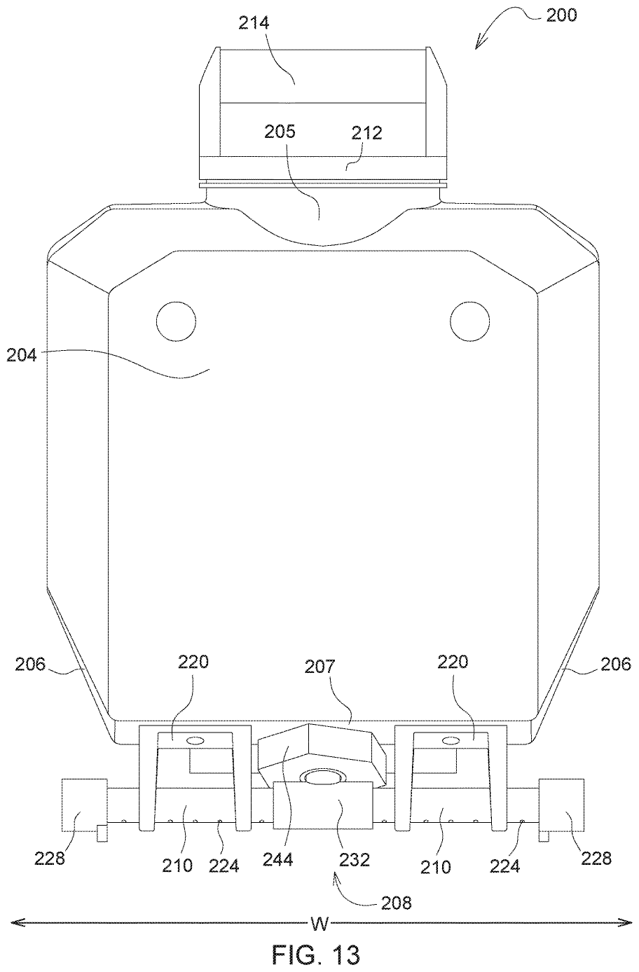

FIGS. 12-17 illustrate a water distribution system 200 for use with the plate compactor 10. The water distribution system 200 provides water to a work surface W (FIG. 13) to help suppress dust kicked up during use of the compactor 10, or to help prevent material from sticking to the baseplate 14 during use. In the illustrated embodiment, the water distribution system 200 is mounted to the frame 30. In other embodiments, the water distribution system 200 may be mounted elsewhere on the compactor 10.

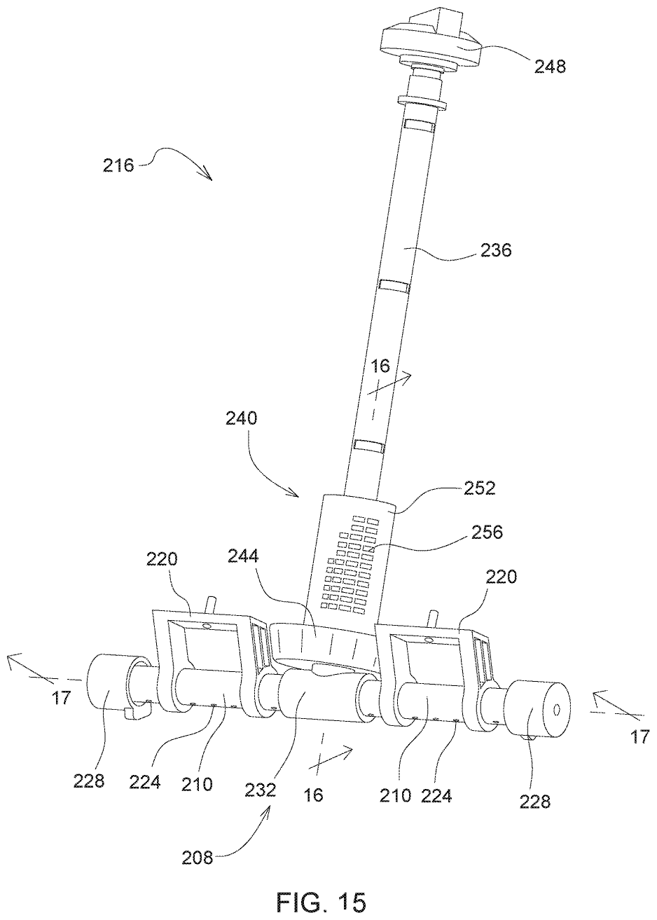

The water distribution system 200 includes a tank 204, a water bar 208, a cap 212, and a flow rate adjustment assembly 216 (FIG. 15) partially located within the tank 204. The tank 204 includes mounting surfaces 206 located on an exterior of the tank 204 to help facilitate the mounting connection between the tank 204 and the frame 30 of the compactor 10. In some embodiments, each of the mounting surfaces 206 includes mating components, such as locating apertures or other locating surfaces (e.g., tapered surfaces), that are configured to coincide with complementary mating components on the frame 30. In other embodiments, a bottom part 207 of the tank 204 includes indents (not shown) configured to receive vibrational isolators located on the baseplate 14.

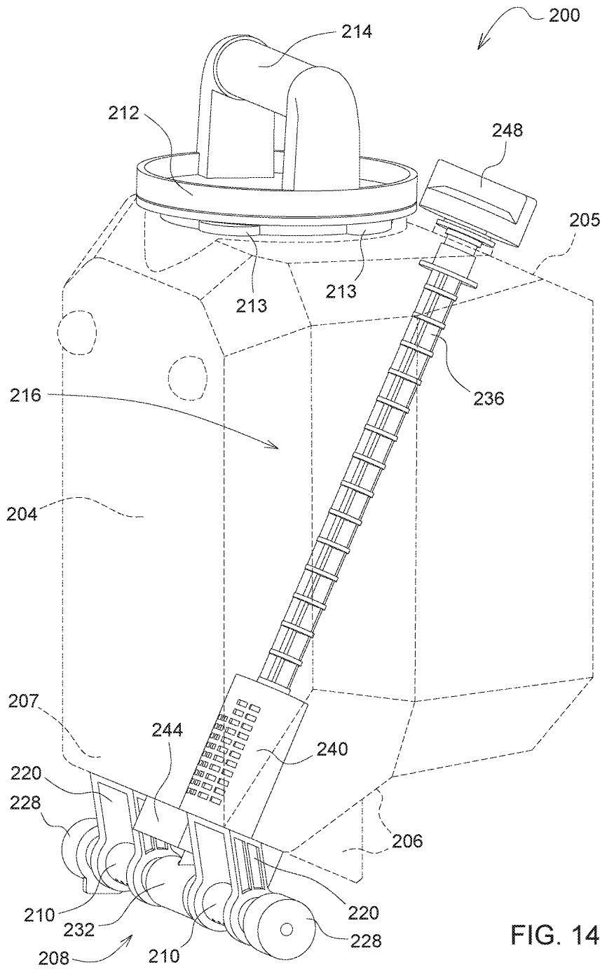

With continued reference to FIGS. 12-17, the tank 204 defines an internal volume that is configured to be filled with water or other fluids. To fill the tank 204 with water, the cap 212 needs to be removed by the user. In the illustrated embodiment, the cap 212 is coupled to the tank 204 via angled surfaces 213 (FIG. 14) located on the cap 212 configured to coincide with angled surfaces located internally on an upper part 205 of the tank 204. In other embodiments, the cap 212 may be coupled to the tank 204 using other methods, such as a threaded connection. The cap 212 also includes a handle 214 for the user to grasp during transport of the tank 204 or cap 212.

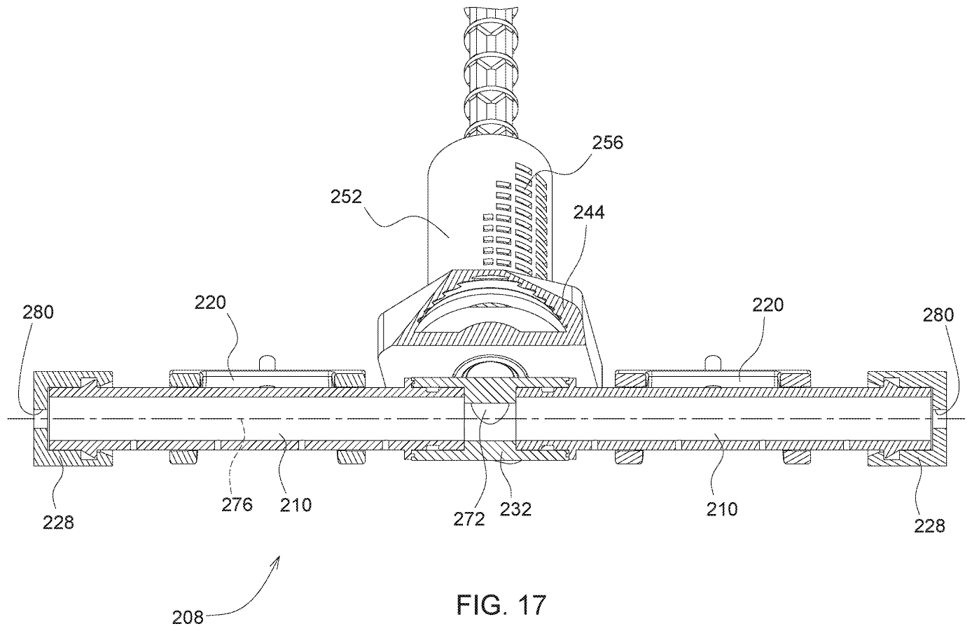

Water is distributed from the tank 204 and onto the work surface W by gravity. Water travels through tank 204 and the water bar 208 and onto the work surface W in front of the baseplate 14. The water bar 208 extends out from a bottom part 207 of the tank 204. The water bar 208 includes a plurality of distribution tubes 210 that are coupled to the bottom part 207 of the tank 204 via respective brackets 220. Each of the distribution tubes 210 extends along the bottom part 207 of the tank 204 along a longitudinal axis 276 (FIG. 17) that is parallel to the work surface W and the plane 15 of the lower surface of the baseplate 14. The water bar 208 also includes a plurality of apertures 224 located on the distribution tubes 210 for distributing the water generally perpendicular to the work surface W, and end caps 228 located on ends of respective distribution tubes 210. In some embodiments the end caps 228 may include apertures 280 through which water is discharged or dripped laterally from each end of the distribution tubes 210 onto the work surface W. The water discharged from the apertures 280 of the end caps 228 is in addition to the water distributed through the apertures 224 of the distribution tubes 210. The end caps 228 are selectively removable from the ends of the distribution tubes 210 to facilitate cleaning of the tubes 210. In some embodiments, the end caps 228 are comprised of an elastomeric material, such as rubber, so the end caps 228 can be easily removed. To control the flow rate of water from the tank 204 and through the water bar 208, the water bar 208 includes a pipe fitting 232 (e.g., a T-shaped fitting) fluidly coupled to the flow rate adjustment assembly 216. In some embodiments, the distribution tubes 210 may be ultrasonic welded to the pipe fitting 232.

With reference to FIGS. 14-17, the flow rate adjustment assembly 216 includes a shaft 236, a valve basket 240 coupled to the shaft 236, a carrier 244 for supporting the valve basket 240 and the shaft 236, and an adjustment knob 248 coupled to the shaft 236. In the illustrated embodiment, the shaft 236 and the valve basket 240 are located within the internal volume of the tank 204, while the adjustment knob 248 and the carrier 244 are located external to the tank 204 on the upper part 205 and bottom part 207 of the tank 204, respectively.

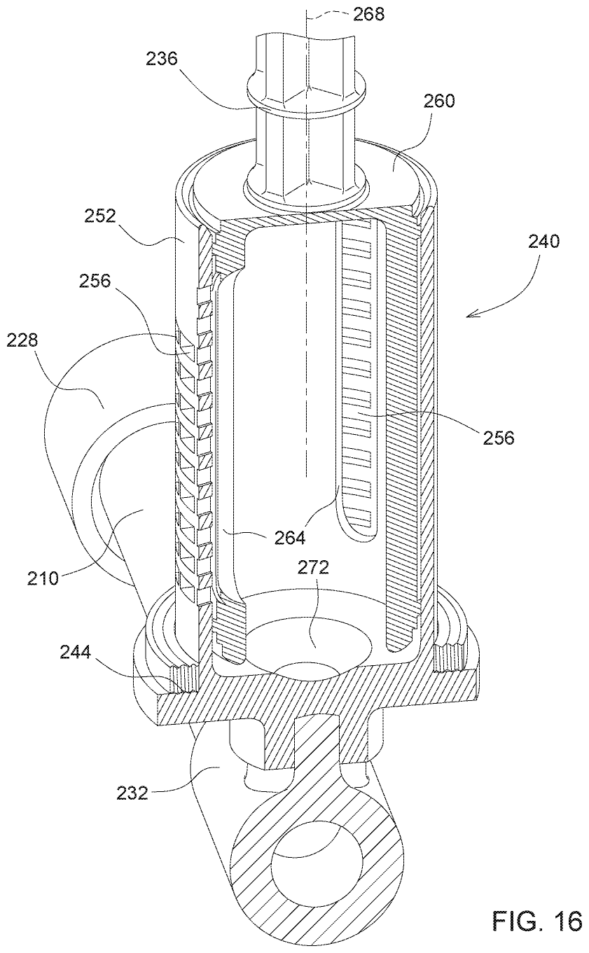

With reference to FIGS. 15 and 16, the basket 240 includes an outer cylinder 252 having a plurality of apertures 256, and an inner cylinder 260 located within the outer cylinder 252 having a plurality of apertures 264 that are oblong shaped. In other embodiments, the apertures 264 may be other shapes. The outer cylinder 252 is fixedly coupled to the carrier 244, while the inner cylinder 260 is rotatably supported on the carrier 244. The shaft 236 is coupled to the inner cylinder 260 and configured to co-rotate with the inner cylinder 260 relative to the outer cylinder 252 about a rotational axis 268. As the shaft 236 and inner cylinder 260 are rotated about the rotational axis 268, one or more of the apertures 264 selectively aligns with the apertures 256 on the outer cylinder 252 to allow water to flow through the valve basket 240. Once the water enters the valve basket 240, the water flows through an opening 272 defined in the carrier 244 and through the pipe fitting 232 into water bar 208. In addition to allowing the water to flow into the valve basket 240, the apertures 256 on the outer cylinder 252 also function as a water filter to filter the water entering the basket 240.

To adjust the flow rate of the water through the water bar 208, the adjustment knob 248 is rotated according to a scale located on the upper part 205 of the tank 204 corresponding to a flow rate. As the adjustment knob 248 is rotated, the shaft 236 co-rotates with the knob 248, which rotates the inner cylinder 260 within the outer cylinder 252 of the basket 240. By rotating the shaft 236, one or more of the apertures 264 of the inner cylinder 260 selectively aligns with the apertures 256 on the outer cylinder 252. By aligning or misaligning these apertures 256, 264, the water flows into the water bar 208 according to the selected flow rate corresponding to the radial position of the adjustment knob 248 on the scale. In some embodiments, when all of the apertures 256, 264 are aligned, the water flow rate is at a maximum. In other embodiments, when all of the apertures 256, 264 are misaligned, the water flow rate is at a minimum. In yet other embodiments, all of the apertures 256, 264 are aligned when the adjustment knob 248 is rotated 90 degrees about the rotational axis 268.

Although the disclosure has described in detail certain preferred embodiments, variations and modifications exist within the scope and spirit of one or more independent aspects of the invention as described.

Various features of the invention are set forth in the following claims.

What is claimed is:

1. A compactor comprising:
a plate having a lower surface defining a plane;
a frame coupled to the plate;
a drive assembly including a motor and an exciter for receiving torque from the motor to vibrate the plate; and
a wheel assembly pivotably coupled to the frame, the wheel assembly including
an axle,
a plurality of wheels coupled to the axle, and
a linkage assembly coupling the axle to the frame, the linkage assembly configured to move the wheels between a deployed position, in which the wheels are tangent with the plane and rearward of the plate, and a stowed position, in which the wheels are positioned above the plate.

2. The compactor of claim 1, wherein the linkage assembly includes:
a first link having a first end pivotably coupled to the frame and a second end pivotably coupled to the axle,
a second link pivotably coupled to the frame and having a distal end, and
a connecting link pivotably coupling the first link to the distal end of the second link.

3. The compactor of claim 2, further comprising a spring configured to impart a moment to one of the first link, the second link, or the connecting link to bias the wheels toward the stowed position.

4. The compactor of claim 3, wherein the spring imparts the moment onto the second link when biasing the wheels toward the stowed position.

5. The compactor of claim 3, wherein the axle is configured to be depressed to pivot the first link downward to lower the wheels into the deployed position against the bias of the spring.

6. The compactor of claim 5, wherein the first link is pivotable about an axis, and wherein the connecting link includes a line of action extending below the axis when the wheels are in the deployed position.

7. The compactor of claim 6, wherein the linkage assembly further includes a step coupled to the connecting link configured to be depressed, and wherein depressing the step toward a support surface of the compactor, and therefore pivoting the connecting link relative to the second link, moves the line of action above the axis.

8. The compactor of claim 1, wherein, when the wheels are moved from the stowed position to the deployed position, the wheels do not intersect the plane.

9. The compactor of claim 1, further comprising a fastening system for selectively mounting a pad to the lower surface of the plate, wherein the fastening system includes a plurality of fasteners tethered to the plate.

10. The compactor of claim 9, wherein the plate further includes
a front side;
a rear side opposite the front side; and
a plurality of apertures on both the front side and the rear side, each of the apertures configured to receive one of the fasteners to couple the pad to the plate.

11. A compactor comprising:
a plate having a lower surface defining a plane;
a frame coupled to the plate;
a drive assembly including a motor and an exciter for receiving torque from the motor to vibrate the plate; and
a fluid distribution system selectively mountable to the frame, the fluid distribution system including
a tank defining an internal volume for storing a fluid,
a plurality of distribution tubes mounted to the tank and extending along a longitudinal axis that is parallel with the plane, the distribution tubes being fluidly coupled to the tank to receive and distribute the fluid, and
a flow rate adjustment assembly for adjusting a fluid flow rate from the tank through the distribution tubes, the flow rate adjustment assembly having
a shaft configured to rotate about a rotational axis,
an adjustment knob coupled to the shaft, and
a valve configured to selectively allow fluid into the distribution tubes in response to rotation of the shaft about the rotational axis.

12. The compactor of claim 11, wherein the fluid distribution system is configured to distribute the fluid onto a work surface positioned forward of the plate.

13. The compactor of claim 11, wherein each of the distribution tubes includes a plurality of apertures configured to direct the fluid generally perpendicular to the plane.

14. The compactor of claim 11, wherein the valve includes an inner cylinder and an outer cylinder, the inner cylinder being rotatable relative to the outer cylinder to selectively align apertures formed in the inner cylinder with apertures formed in the outer cylinder.

15. The compactor of claim 14, wherein the outer cylinder is fixed relative to the tank, and wherein the inner cylinder is coupled to the shaft for co-rotation with the adjustment knob.

16. The compactor of claim 11, wherein the fluid distribution system further includes at least one removable end cap coupled to an end of one of the distribution tubes to facilitate cleaning of the distribution tube.

17. A compactor comprising:
a plate having a lower surface defining a plane;
a frame coupled to the plate;
a drive assembly configured to vibrate the plate;
a protective pad removably mountable to the lower surface of the plate; and
a fastening system configured to secure the protective pad to the plate,
wherein the fastening system includes:
a plurality of fasteners configured to engage corresponding apertures formed in the plate, and
a plurality of tethers securing the respective fasteners to the plate or the protective pad such that the fasteners remain attached to the plate or the protective pad when the protective pad is removed from the plate.

18. The compactor of claim 17, wherein the protective pad includes a bracket embedded within the protective pad, and wherein the bracket includes an aperture configured to receive one of the fasteners.

19. The compactor of claim 17, wherein the plate includes a front side and a rear side opposite the front side, and wherein the plurality of fasteners includes a first fastener securing the protective pad to the front side of the plate and a second fastener securing the protective pad to the rear side of the plate.

20. The compactor of claim 17, wherein each of the fasteners includes an external thread configured to mate with an internal thread formed in a corresponding plurality of blind bores in the plate.
